(19) United States
(12) Patent Application Publication
(10) Pub. No.: US 2009/0312929 A1
(43) Pub. Date: Dec. 17, 2009

(54) METHOD AND DEVICE FOR IDENTIFYING A PASSIVE ROLLING MOMENT OF A MOTOR VEHICLE

(75) Inventors: Bernd Doebele, Salem (DE); Norbert Wiencek, Hagnau (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/306,604

(22) PCT Filed: Jun. 6, 2007
(86) PCT No.: PCT/EP07/55567

§ 371 Date: Dec. 24, 2008

(30) Foreign Application Priority Data
Jun. 29, 2006 (DE) 10 2006 030 157.9

(51) Int. Cl. G06F 19/00

(52) U.S. Cl. 701/66

(57) ABSTRACT

Method for identifying a passive rolling moment of a motor vehicle (1), for example an undesired rolling moment with which the vehicle (1) starts moving in a direction opposite to a direction of travel in relation to a selected speed. According to the method, a mechanism detects reverse rotational directions of a secondary side (11) of an automatic starting element (4) which is connected to a transmission input shaft (12) of a variable speed transmission (3) in relation to a primary side (9) of the start-up element (4) connected to a driving shaft (10) of a drive engine (2), a transmission oil pump (16) which delivers independently of the rotational direction being associated with the variable speed transmission (3). The method and device provide a simple and inexpensive way for identifying reverse rotational directions close to the beginning of a starting process. For this purpose, the number of revolutions of the transmission input shaft (12) and the oil pressure in the variable speed transmission (3) are detected in a time-resolved manner and subjected to a correlation examination by way of which unequal rotational directions of the primary side (9) and of the secondary side (11) of the starting element (4) are detected when there is insufficient correlation and, as a result, drive-related measures are taken to counteract an identified undesired passive rolling moment. A device for carrying out the method is also disclosed.

This application is a national stage completion of PCT/EP2007/055567 filed Jun. 6, 2007 which claims priority from German Application Serial No. 10 2006 030 157.9 filed Jun. 29, 2006.

### FIELD OF THE INVENTION

The present invention relates to a method and a device for identifying a passive rolling moment of a motor vehicle

### BACKGROUND OF THE INVENTION

In motor vehicles with automatic or automated manual transmissions, an automated start-up element, in particular a start-up clutch is activated during starting, stopping or shifting procedures, by means of which the drive train is coupled to the drive engine. For this purpose, different operational sensor data, like, for example, engine speed, the number of revolutions of the transmission input shaft, an accelerator position, a driving speed as well as intended gear switching, are transmitted to an electronic control device and, after a corresponding evaluation, the start-up clutch is either disengaged or engaged, if necessary with a variable degree of disengaging and/or engaging, in order to guarantee faultless and comfortable driving. Thus, a driver-activated clutch pedal may be dispensed with.

Normally, the start-up clutch is disengaged, in particular when the vehicle stops, in order to prevent the internal combustion engine from choking, if its number of revolutions drops below an idle speed and/or in order to limit a tendency to crawl which may occur in automatic transmissions, when the idle gear is engaged with released brakes. In such an operating status, the effect of a current driving resistance corresponding to the road gradient, the road condition, among other things, may cause the vehicle to start moving passively in a rolling direction, i.e., without introducing a drive torque via the drive engine, when the transmission is friction-coupled with the driven vehicle wheels, where the rolling direction may either correspond or be opposite to a selected forward speed or reverse speed, or alternatively to the driver's start-up request.

If the rolling direction is opposite to the direction of travel in relation to a selected speed, for example, the vehicle starts rolling with an engaged reverse speed on a road gradient in the forward direction, the transmission input shaft and driving shaft of the drive engine, and consequently the secondary side as well as the primary side of the start-up element, correspondingly also move in the opposite direction, i.e., in reversing and hence the reverse rotational directions.

This intrinsically irregular operating condition should possibly be promptly ended by blocking the vehicle, in order to avoid uncontrolled speed increases and inadmissible high speeds of the clutch elements, for example the friction disks. If the motor vehicle is blocked by means of the clutch, either the direction of travel of the vehicle may be reversed to the selected direction of travel or the engine speed may abruptly drop at the time of engaging the clutch, dependent on the kinetic energy of the vehicle, in an extreme case, even reversing the rotational direction of the drive engine.

In particular, in the case of heavy commercial vehicles which are increasingly equipped with automated manual transmissions connected to an automatic clutch, rolling situations that are difficult to control by the driver because of uncontrolled rolling may present, on steep slopes or ramps, an increased wear and even damage to components of the drive train (clutch, engine, transmission) upon engaging the start-up clutch.

From DE 199 32 052 A1, a method for identifying the direction of rotation of a transmission input shaft of an automated transmission, in which the time progression of the output speed or an equivalent dimension, for example, the progression of the brake pressure, is compared to the different characteristics, for example, of an output speed characteristic for a driving status “forward drive up a slope with reverse rolling with load” stored in an electronic data carrier. The respective points of synchronicity, at which the clutch switching pressure may be activated, are calculated as a function of the calculated driving condition. By calculating the points of synchronicity which consider vehicle rolling against the selected direction of travel, an unfavorable clutch actuation sequence leading to loss of comfort and clutch and transmission overload may be prevented.

The known method functions without an additional travel direction sensor or revolution sensor, which is configured sensitive to the rotational direction, consequently resulting in cost savings. This provides an effective means for the protection of the clutch and the transmission during the described rolling moments. The disadvantage is, however, that the validity check based on the stored characteristics requires a relatively time-consuming and complex calculation algorithm, which may result in switching delays during normal switching, until the actual driving status, possibly including further parameters, like a torque request based on the accelerator position or brake pedal actuation, is clearly allocated. Moreover, the characteristics are specific for each vehicle type, so that verification, and possibly adaptation, is required for each vehicle type used. Furthermore, a relatively expensive data storage unit as well as a rapid signal transmission unit is required.

From DE 10 2004 057 122 A1 of the applicant, a further method for identifying the rotational direction of the secondary side of a start-up clutch is known, in which the start-up clutch is engaged with a variable degree of closing, if the current speed on the secondary side of the clutch, i.e., on the transmission side, is higher than the actual speed on the primary side, i.e., on the engine side. The clutch closure degree is thus adjusted dependent on the acceleration of the secondary number of revolutions.

Subsequently, the number of revolutions of the drive engine is adjusted to a nominal number of revolutions, preferably the secondary number of revolutions, by means of an engine control. Consequently, if the primary number of revolutions and the secondary number of revolutions equalize within a specified time, the same rotational direction of the secondary side and the primary side of the start-up clutch is detected. If, in contrast, the engaging of the start-up clutch caused the primary number of revolutions and/or the number of revolutions of the engine to decrease below a threshold value, in particular during idle-running speed, the opposite rotational direction of the secondary side is detected.

This method likewise works without a complex sensor for detecting the rotational direction. In addition, no characteristic curve memory or adaptation to each specific type of vehicle is necessary, resulting in further cost savings.

The disadvantage is that, in each case, the clutch has to be engaged at least to a certain degree first, and may only be engaged in reverse rotational directions of the clutch sides on actuation of this engaging procedure. This requires preventive measures for protecting the clutch from excessive load at high differences in the number of revolutions in the opposite direction of the rotational directions, in particular rapid control commands for opening the clutch or switching the transmission to a safe neutral position. Moreover, with this method, the fuel consumption and wear may be increased by additional clutch switches and engine speeds.

### SUMMARY OF THE INVENTION

Against this background, it is an object of the present invention to specify a method and a device for identifying a passive rolling moment of a motor vehicle, which detect reverse rotational directions between a motor-sided driving shaft and a transmission-sided transmission input shaft near to the beginning of a rolling moment of this type and which nevertheless are simple and cost-effective.

The present invention takes advantage of the fact, that many automobiles and normally all large commercial vehicles are equipped with a transmission oil pump whose supply depends on the rotational direction and whose rotational direction is coupled to the rotational direction of the transmission input shaft. The present invention is based on the knowledge, that the oil pressure in a transmission, with an oil pump of this type, may be utilized as an indicator of the rotational direction of the transmission input shaft.

Accordingly, the present invention is based on a method of identifying a passive rolling moment of a motor vehicle, for example an undesired rolling moment, with which the vehicle starts moving in a direction opposite to a direction of travel in relation to a selected speed, with means to detect reverse rotational directions of a secondary side of an automatic start-up element connected to a transmission input shaft of a variable speed transmission in relation to a primary side of the start-up element connected to a driving shaft of the drive engine, whereby a transmission oil pump, whose supply depends on the rotational direction is associated with the variable speed transmission.

A passive rolling moment is understood as a rolling moment and/or vehicle starting movement, in particular in a direction against a desired direction of travel, in which the driving resistance is such that, with a friction locked transmission, the vehicle starts moving without the drive engine introducing a driving torque.

An automatic start-up element is understood as all clutch systems which do not require activation by the driver; especially start-up clutches which may be controlled via an electronic control device, but also self-acting clutch types, for example centrifugal clutches which turn into centrifugal clutches depending on the number of revolutions of the engine.

In order the attain the above mentioned object, the present invention provides that the number of revolutions of the transmission input shaft and the oil pressure in the variable speed transmission are recorded in a time-resolved manner and correlation tested, by means of which unequal rotational directions of the primary side and the secondary side of the start-up element are detected in case of insufficient correlation, and as a result drive-related measures are taken to counteract an identified undesired passive rolling moment.

Many vehicle transmissions, in particular commercial vehicle transmissions, have transmission oil pumps for lubricating and cooling the transmission and whose rate of supply usually depends on the rotational direction. Consequently, a lubricating oil pump of this type only supplies, or at least only supplies correctly if its drive, i.e., the transmission input shaft, rotates in the correct direction, i.e., in the same direction as the driving shaft of the drive engine. Hence, there is a clear correlation between the rotational direction of the secondary side of the clutch and the lubricating oil in the transmission.

Thus, by means of this method, a simple and cost-effective monitoring of the rotational direction of the transmission input shaft is enabled in all vehicles equipped in this manner, which reliably detects a reversal of the rotational direction resulting from the vehicle moving in the opposite direction of the speed currently selected by the driver, without an additional rotational direction sensor, complex calculation algorithms, or characteristic curve comparisons, and without any, as the case may be, attempted clutch actuation. In particular, as is provided in an especially advantageous embodiment of the present invention, a reversed rotational direction of the transmission input shaft may be deduced from an increase of the number of revolutions of the transmission input shaft, which does not cause an increase in the oil pressure in the speed change transmission. For this purpose, minor rolling with a corresponding increase in the number of revolutions of the transmission input shaft, during which no oil pressure or oil pressure increase is measured in the transmission, is sufficient for rapidly and securely detecting rotational directions of both clutch sides in the opposite direction.

Since as a rule an advantageous rotational direction-invariant revolution sensor for the transmission input shaft as well as a pressure-sensitive means (pressure switch or pressure sensor) for monitoring the oil pressure in the transmission are available in automated transmissions with a transmission oil pump, and the number of revolutions of the engine is available anyway, there is no additional expenditure in components for the method, according to the present invention, which is thus especially cost-effective and saves installation space and weight.

Besides the progression of the number of revolutions of the transmission input shaft, only information like “lubricating oil equal to zero” and/or “lubricating oil unequal to zero” is necessary in the simplest case for monitoring the rotational direction. Hence, a particularly cost-effective, simple oil pressure switch is sufficient to perform the procedure. Thereby, extensive protection of the clutch and possibly the transmission against damage during reverse rotational directions is ensured.

In the case of a pressure sensor, it may additionally be used for monitoring the filling quantity and/or the oil level in the transmission, whereby a signal may indicate that there is insufficient oil in the transmission and activate possible error responses and/or protective measures, consequently achieving a further increase in the operational safety of the vehicle. In addition, it may thus be ensured that insufficient oil pressure, due to a defect owing to an oil leak, for example, is not misleadingly interpreted as a reverse rotational direction.

Exact recording of the progression of the pressure of the transmission oil by means of a pressure sensor, as may be further provided, is possible in order to monitor an increase and/or decrease in the lubricating oil pressure.

A passive rolling moment in the respectively selected direction of travel may also be detected from the pressure progression, for example, when the transmission input shaft runs ahead of the driving shaft at a higher speed, by comparing the pressure progression to the progression of the number of revolutions of the input shaft, in order to also thereby prevent an uncontrolled speed increase and facilitate comfortable clutch engaging by means of a corresponding clutch control.

If a reverse rotational direction is detected at the start-up clutch, the vehicle may be blocked by means of the clutch, if in doing so a clutch load associated with the closing procedure remains in an admissible range or otherwise the clutch may be left disengaged. Thus, the degree of clutch closure relative to the contact pressure and time progression may be variable, in order to achieve a switching comfort as high as possible and, at the same time, avoid excessive clutch load, whereby the differential speed between the speed of the driving shaft and the number of revolutions of the transmission input shaft, in particular, can be used as a parameter for predetermining the expected clutch load taking into account the rotational directions of these shafts. In order to protect the clutch, for example, at differential numbers of revolutions above a specified threshold value, the clutch remains disengaged. In order to predetermine the clutch load, essentially all available relevant operational parameters, for example the vehicle weight, the road gradient and the rolling direction, forward rolling with engaged reverse speed or reverse rolling with engaged forward speed for example, may be taken into account.

Further measures as a consequence of detected reverse rotational directions are possible. For example the transmission may be switched to neutral.

An active braking support of the driving brake of the vehicle is also conceivable, in order to safely bring the vehicle to a halt before a new start-up is attempted. Thus, the protection of the clutch and of the transmission against damage during reverse rotational directions as well as the driving safety may further be improved.

In addition, it may be provided that, in case of a start-up clutch switching dependent on the number of revolutions of the engine, the actuation of the start-up clutch is controlled via a speed control of the drive engine during a detected rolling moment. Thus the method may also be advantageously used with self-acting centrifugal clutches. In particular the number of revolutions of the engine may be acted upon, via an engine control, such that the clutch is either actuated or not actuated, depending on the expected clutch load.

A device that is well suited for carrying out the above mentioned method is described below.

Thus, the present invention is further based on a device for detecting a passive rolling moment of a motor vehicle having a drive engine that is connected to the primary side of an automatic start-up element via a driving shaft, with a variable speed transmission, which is connected to the secondary side of the start-up element via a transmission input shaft, whereby the variable speed transmission has a transmission oil pump whose supply depends on the rotational direction and the means for at least recording the number of revolutions of the transmission input shaft and the transmission oil pressure dependent on the supply of the transmission oil pump.

To attain the above mentioned object with regard to the device, the present invention additionally provides, that a control device is available, into which at least the signals from the number of revolutions of the transmission input shaft and transmission oil pressure or equivalent signals may be input time-resolved and compared to one another, whereby unequal rotational directions of the secondary side and the primary side of the start-up element may be calculated by means of the control device, and by means of which output signals dependent on the rotational direction may at least be generated for controlling the start-up element.

The control device facilitates a fast detection of unequal rotational directions of the drive engine and the transmission on the basis of the available transmission oil pressure signals from the oil pump whose supply depends on the rotational direction and from signals of the number of revolutions of a transmission input shaft. The control device may be integrated in an already available control device for controlling the automatic start-up element in an especially cost-effective manner, so that no components that require additional installation space are necessary.

### BRIEF DESCRIPTION OF THE DRAWINGS

A drawing of an exemplary embodiment is attached to the description for the purpose of exemplification of the present invention. The drawing shows

FIG. 1 is a schematic illustration of the drive train of a commercial vehicle with an automatic clutch,

FIG. 2 is a diagram for the correlation between the lubricating oil pressure and the rotational direction of the transmission input shaft, and

FIG. 3 is an additional diagram for the correlation between the lubricating oil pressure and the rotational direction of the transmission input shaft.

### DETAILED DESCRIPTION OF THE INVENTION

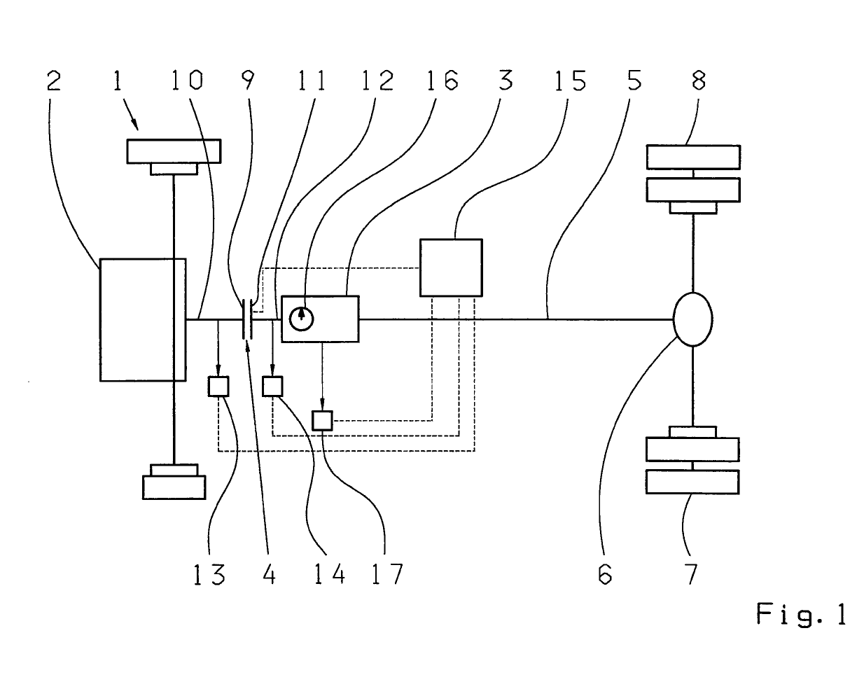

FIG. 1 thus shows a commercial vehicle 1 with a drive engine 2, configured as an internal combustion engine, and a variable speed transmission, configured as an automatic manual transmission 3. The drive engine 2 and the transmission 3 are frictional engaged with one another via an automatic start-up element 4, configured as a friction clutch. The automatic start-up clutch 4 may be controlled via an actuator (not illustrated) by means of a control device 15. The drive torque of the drive engine 2 transmitted via the transmission 3 may be transmitted in the known manner to the driven vehicle wheels 7, 8 of the commercial vehicle 1 via a transmission input shaft 5 and a differential 6.

The start-up clutch 4 is connected, on its primary side 9, to the drive engine 2 via a driving shaft (crank shaft) 10 and, on its secondary side 11, via a transmission input shaft 2 leading into the transmission 3. Furthermore, the driving shaft 10 and the transmission input shaft 12 are associated with revolution sensors 13 and 14 by which the number of revolutions of the driving shaft 10 and of the transmission input shaft 12 may be conveyed to the control device 15.

The transmission 3 has an oil pump 16 for lubricating and cooling which is drively connected to the transmission input shaft 12 and supplies lubricating oil, depending on the rotational direction of the transmission input shaft 12, as well as generates lubricating oil pressure in the transmission 3. Finally, there is an oil pressure sensor 17, via which an output signal of the oil pressure value in the transmission 3 may be transmitted to the control device 15.

An exemplary embodiment of the method, according to the present invention, is described below with reference to a typical operational scenario of such a commercial vehicle 1.

The vehicle 1 is standing on a slope and has to be maneuvered uphill in the reverse direction. Ideally, the vehicle 1 would start moving in the intended direction, i.e., in the reverse direction, with the engaged reverse gear, when the start-up clutch 4 is engaged. The primary side 9 of the start-up clutch 4 with the driving shaft 10 and the secondary side 11 with the transmission input shaft 12 consequently have the same rotational direction and, with a non-slip friction-locked connection, also have the same number of revolutions, i.e., the number of revolutions of the engine.

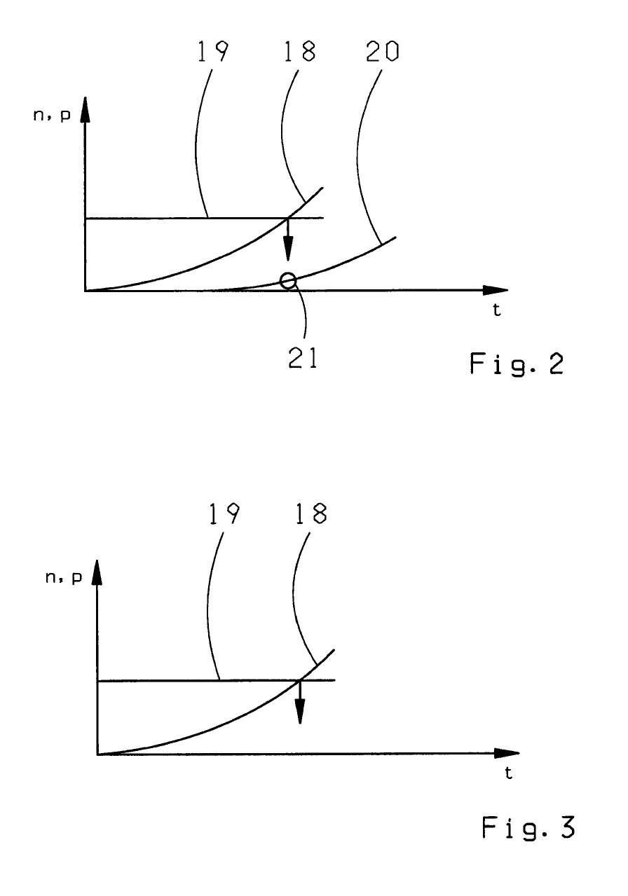

For this purpose, FIG. 2 shows a simplified illustration of an exemplary progression of the number of revolutions 18 of the transmission input shaft 12 in comparison to an the number of revolutions of the engine 19 and an oil pressure progression 20 of the transmission oil pump 16, whereby the speed n and/or the pressure p are plotted over the time t. The control device 15 records a regular rolling moment at a point in time 21, at which the number of revolutions of the transmission input shaft 12 matches the number of revolutions of the drive engine 2, and an accordingly correct oil pressure greater than zero is generated by the oil pump 16 and established by the pressure sensor 17. However, due to the driving resistance on the road gradient, the vehicle 1 begins to roll in the forward direction with engaged reverse gear and a still disengaged start-up clutch 4, which corresponds to an irregular passive rolling moment. During this process, the transmission input shaft 12 is driven via the vehicle wheels 7 and 8, the differential 6, the transmission output shaft 5 and the transmission 3. Due to the forward motion of the vehicle 1 actively connected to the engaged reverse speed, the rotational direction of the transmission input shaft 12 is reversed, so that the transmission input shaft 12 and also the secondary side 11 of the start-up clutch rotate in the opposite direction of the driving shaft 10 and thus the primary side 9 of the start-up clutch 4.

The result of the unequal rotational directions of the engine 1 and the transmission input shaft 5 is shown in FIG. 3. Although the number of revolutions 18 of the transmission input shaft increases by the vehicle 1 starting to move, the control device 15 does not record any lubricating oil pressure and/or a pressure equal to zero or at least an increase in the lubricating oil pressure. The control device 15 thereby detects reverse rotational directions relative to the start-up clutch 4 and provides a corresponding signal value. This value may be further processed with the current difference in the number of revolutions and advantageously with additionally available operational parameters.

As a result, a signal is output by means of which the start-up clutch 4 is either controlled, in order to block the vehicle 1 and start to move it in the desired direction, or by means of which the start-up clutch 4 remains disengaged in the first instance, in order to prevent an impending clutch overload and/or choking of the drive engine 2 and to trigger further possibly required measures.

### REFERENCE NUMERALS

1 Motor vehicle
2 Drive engine
3 Variable speed transmission
4 Start-up element
5 Transmission output shaft
6 Differential
7 Vehicle wheel
8 Vehicle wheel
9 Primary side of the clutch
10 Drive shaft
11 Secondary side of the clutch
12 Transmission input shaft
13 Revolution sensor
14 Revolution sensor
15 Control device
16 Transmission oil pump
17 Oil pressure sensor
18 Speed progression of the transmission input shaft
19 Speed of the drive engine
20 Progression of the transmission oil pressure
21 Point in time
n Rotational speed ordinate
p Pressure ordinate
t Time abscissa

1-11. (canceled)

12. A method for identifying a passive rolling moment of a motor vehicle (1) in which vehicle (1) starts moving in a direction opposite to a direction of travel in relation to a selected speed, the vehicle having means for detecting a reverse rotational direction of a secondary side of an automatic start-up element (4) connected to a transmission input shaft (12) of a variable speed transmission (3) in relation to a primary side (9) of the start-up element (4) connected to a driving shaft (10) of a drive engine (2), and a transmission oil pump (16) whose supply depends on the rotational direction associated with the variable speed transmission (3), the method comprising the steps of:
detecting a number of revolutions of the transmission input shaft (12) and an oil pressure in the variable speed transmission (3) in a time-resolved manner and subjected to a correlation test by which unequal rotational directions of the primary side (9) and of the secondary side (11) of the start-up element (4) are detected, and when there is insufficient correlation and, as a result, taking drive-related measures to counteract an undesired passive rolling moment.

13. The method according to claim 12, further comprising the step of deducing a reverse rotational speed of the transmission input shaft (12) from an increase in the number of revolutions of the transmission input shaft (12), which does not generate an increase in the oil pressure of the variable speed transmission (3).

14. The method according to claim 12, further comprising the step of using a start-up clutch as the start-up element (4), the start-up clutch (4) otherwise remains disengaged in case of a detected undesired passive rolling moment is at least close to a predetermined variable closure degree, if as a result thereof a predetermined maximum admissible clutch load is not exceeded.

15. The method according to claim 14, further comprising the step of determining the maximum admissible clutch load by at least the differential number of revolutions between the driving shaft (10) and the transmission input shaft (12), taking into account the rotational directions of the shafts (10, 12).

16. The method according to claim 12, further comprising the step of, with the start-up clutch (4) switching dependent on the number of revolutions of the engine, controlling the actuation of the start-up clutch (4) via a speed control of the drive motor (2) when a passive rolling moment is detected.

17. The method according to claim 12, further comprising the step of monitoring the transmission oil pressure via a pressure switch.

18. The method according to claim 12, further comprising the step of monitoring the transmission oil pressure via a pressure sensor (17).

19. The method according to claim 18, wherein the pressure monitoring of the transmission oil pressure further comprises the step of monitoring of an oil level in the transmission (3).

20. The method according to claim 12, further comprising the step of recording a time-dependent pressure progression of the transmission oil pressure.

21. The method according to claim 20, further comprising the step of, by the recorded time-dependent progression of the transmission oil pressure, detecting a passive rolling moment in the selected direction of travel.

22. A device for identifying a passive rolling moment of a motor vehicle having a drive engine (1) that is connected to the primary side (9) of an automatic start-up element (4) via a driving shaft (10), with a variable speed transmission (3) that is connected to the secondary side (11) of the start-up element (4) via a transmission input shaft (12), the variable speed transmission (3) having a transmission oil pump (16) whose supply depends on the transmission oil pressures, characterized in that a control device (15) is provided in which at least the signals related to the number of revolutions of the transmission input shaft and the transmission oil pressure or equivalent signals may be input time-resolved and compared to one another, whereby unequal rotational directions of the secondary side (11) and the primary side (9) of the start-up element (4) may be calculated by means of the control device (15), and by means of which at least output signals related to the rotational direction may be generated for controlling the start-up element (4).
